(19) United States
(12) Patent Application Publication
(10) Pub. No.: US 2007/0209708 A1
(43) Pub. Date: Sep. 13, 2007

(54) Bag Assembly for the Separation of a Composite Liquid and Method for Manufacturing it

(75) Inventors: Kristina Hermann, Arvada, CO (US); Victor Dolecek, Centennial, CO (US); Johan-Petter Hogstrom, Hagersten (SE); Charles Hake, Arvada, CO (US); Johan Dahlberg, Taby (SE); James Ladtkow, Broomfield, CO (US); Michael Martinez, Golden, CO (US); Peter Nordgren, Stockholm (SE); Brian M. Holmes, Lakewood, CO (US); Robert Fiore, Evergreen, CO (US)

Correspondence Address: GAMBRO, INC;PATENT DEPARTMENT, 10810 W COLLINS AVE, LAKEWOOD, CO, 80215, US

(73) Assignee: GAMBRO, INC., Lakewood, CO (US)

(21) Appl. No.: 11/570,519

(22) PCT Filed: Jun. 8, 2005
(86) PCT No.: PCT/US05/20708

§ 371 Date: Dec. 13, 2006

Related U.S. Application Data
(60) Provisional application No. 60/582,385, filed on Jun. 22, 2004.

(51) Int. Cl. F17D 1/08

(52) U.S. Cl. 137/255

(57) ABSTRACT

A bag assembly for the separation of a composite liquid into at least two components, comprises a set of bags and a bag-assembling device for assembling the set of bags. The set of bags comprises a separation bag connected by a product tube to at least one product bag. The bag-assembling device comprises a support member; a mounting means, connected to the support member, for removably mounting the bag-assembling device in a rotor of a centrifuge having a central cavity for containing the product bag; and a first securing means connected to the support member for releasably securing the product bag to the support member. The mounting means and the first securing means are so arranged that the product bag occupies a determined position in the central cavity of a rotor when the bag-assembling device in mounted therein.

The present invention concerns a bag assembly for the separation of a composite liquid into at least two components and a method for manufacturing such a bag assembly.

### BACKGROUND OF INVENTION

The bag assembly of the invention is particularly appropriate for carrying out various methods for the separation of biological fluids comprising an aqueous component and one or more cellular components. Such methods include, for example: extracting a platelet component from several concentrated platelet components pooled together; extracting a plasma component and a red blood cell component from a volume of filtered blood obtained by flowing a volume of whole blood through a filter, removing platelets and white blood cells therefrom; extracting a plasma component, a platelet component and a red blood cell component from a volume of filtered blood obtained by flowing a volume of whole blood through a filter, removing white blood cells therefrom; extracting a plasma component and a cellular component (including platelets, white blood cells, and red blood cells) from a volume of whole blood, the cellular component being subsequently filtered so as to remove platelets and white blood cells therefrom; extracting a plasma component, a platelet component, and a red blood cell component from a volume of whole blood, the white blood cells being subsequently removed by filtration from the platelet component and the red blood cell component.

The international patent application WO 2004/018021 describes a machine for the separation of blood components and a bag set designed for cooperating with this centrifuge machine.

The bag set comprises:
a separation bag having an annular or a partially annular chamber delimited by an outer circular edge and an inner circular edge;
two or three product bags that are connected by tubes to the separation bag, at the inner edge thereof;
an optional secondary product bag connected by a tube to one of the product bags;
an optional collection bag connected by a tube to the separation bag, at the inner edge thereof; and
one or more white blood cell filter(s) optionally connected to one or more tubes.
   The bags and the tubes of this bag set are made of flexible plastic material. They are pre-connected and the bag set is sterilized before use.

The blood product separation machine described in the international patent application WO 2004/018021 comprises:
a centrifuge having a rotor that is coupled to a motor adapted to rotate the rotor at such rotation speeds suitable for the separation of blood components. The rotor comprises a shaft having a hollow upper portion defining a container for receiving blood product bags, and a turntable connected to the upper part of the container. The turntable includes an annular chamber that can be closed by a lid and define therewith a separation chamber designed for receiving a separation bag. Pinch valves are mounted on the rotor for selectively closing and opening the tubes connecting the product bags to the separation bag.
a hydraulic system for pumping a hydraulic liquid in and out an annular hydraulic chamber defined within the separation chamber by a flexible annular diaphragm partially lining the turntable. When the hydraulic liquid is pumped into the hydraulic chamber, the hydraulic chamber expands within the separation chamber, and, if a separation bag full of liquid is present therein, causes a transfer of the content of the separation bag into one of the products bags.
a control system for essentially controlling the motor coupled to the rotor, i.e. the rotation speed of the motor, the hydraulic system, and the pinch valves mounted on the rotor.

The manipulation of a set of bags of the above mentioned type, which can comprise up to six flexible bags interconnected by flexible tubes of variable lengths, both during the manufacture of the bag set and during its setting in place in a separation machine and its withdrawal therefrom may sometimes be cumbersome. Also, if it happens during a steam sterilization process that a tube kinks, the inner walls of the tube that are in contact usually weld together at the kink and the whole set has to be subsequently discarded.

An object of the invention is to design a bag assembly that is both easy to manufacture and to manipulate.

### SUMMARY OF INVENTION

According to the invention, a bag assembly for the separation of a composite liquid into at least two components, comprises:
a set of bags comprising:
   a separation bag;
   at least one product bag, and
   a product tube connecting the separation bag to the at least one product bag;
a bag-assembling device for assembling the set of bags comprising:
   a support member;
   a mounting means, connected to the support member, for removably mounting the assembling device in a rotor of a centrifuge having a central cavity for containing the at least one product bag; and
   a first securing means connected to the support member for releasably securing the at least one product bag to the support member,
   wherein the mounting means and the first securing means are so arranged with respect to each other that the at least one product bag occupies a determined position in the central cavity of a rotor when the assembling device in mounted therein.

According to the invention, a bag-assembling device for assembling a set of bags comprising a separation bag, at least one product bag, and a product tube connecting the separation bag to the at least one product bag, comprises:
a support member;
a mounting means, connected to the support member, for removably mounting the bag-assembling device in a rotor of a centrifuge having a central cavity for containing the at least one product bag; and
a first securing means connected to the support member for releasably securing the at least one product bag to the support member,
wherein the mounting means and the first securing means are so arranged with respect to each other that the at least one product bag occupies a determined position in the central cavity of a rotor when the bag-assembling device in mounted therein.

Additional or alternative features of the invention are as follows:
The bag assembly comprises a plurality of products bags, and the first securing means is adapted to releasably secure the product bags to the support member so that they form a compact stack.
The first securing means is adapted to secure at least one product bag to the support member by a peripheral edge thereof.
The at least one product bag is substantially rectangular and the first securing means is adapted to secure the product bag to the support member by an upper edge thereof.
The first securing means is adapted to secure at least one product bag to the support member by at least two areas thereof.
The first securing means comprises at least two spaced apart protruding elements for engaging two holes in a peripheral area of at least one product bag.
The first securing means further comprises at least two straps, and each strap has a first end connected to the support member and a second end connectable to one of the protruding elements so as to prevent a bag engaged on the protruding element from escaping therefrom.
The support member comprises an elongated body having two opposite lateral sides, the first and second protruding elements comprise two rods extending substantially perpendicularly from one side of the body of the support member, and each rod has a tip fitted with a retaining extension for preventing a bag engaged on the rods from escaping therefrom.
The support member comprises a first and a second U-shaped elements having a straight flat base, the first and a second U-shaped elements are releasably connectable so that their respective straight flat base are substantially parallel and define an oblong gap therebetween, and the two spaced apart protruding elements comprise two substantially parallel rods that are connected to the straight flat base of the first U-shaped elements and extend across the oblong gap to the straight flat base of the second U-shaped elements.
The support member comprises a first and second flaps hinged together and the at least two spaced apart protruding elements extend from an outside surface of the flaps.
The bag assembly comprises a plurality of product bags and the first securing means comprises four spaced apart protruding elements, two protruding elements extending from the first flap and two protruding elements extending from the second flap.
The first securing means comprises at least one a jaw for releasably grasping at least one product bag along a portion of a peripheral edge thereof.
The bag assembly comprises a plurality of products bags, the support member comprises an elongated body having two lateral sides, and the first securing means comprises two jaws respectively hinged to either side of the elongated body.
The mounting means is connected to the support member so that the support member intersects a rotation axis of the rotor when the bag-assembling device is mounted in the rotor.
The support member comprises an elongated portion having two lateral ends, and the mounting means comprises two extensions extending at both ends of the elongated portion of the support member, wherein the two extensions are adapted to engage two corresponding recesses in a wall of a central cavity of a rotor so that the support member extends across the cavity of the rotor when the lateral extensions are engaged in the recesses thereof.
The support member comprises an elongated body having two opposite lateral sides, and the mounting means comprises a first and second protruding elements extending from one side of the body of the support member, wherein the protruding elements have tips adapted to engage two recesses in a portion of a wall of a central cavity of a rotor so that the support member extends substantially along the portion of wall when the protruding elements are engaged in the recesses thereof.
The mounting means and the first securing means are so arranged with respect to each other that the at least one product bag hangs substantially in an upright position when the bag-assembling device is mounted in the rotor of a centrifuge.
The bag assembly further comprises a second securing means connected to the support member for releasably securing the separation bag thereto.
The first securing means and the second securing means are so arranged with respect to each other that the product tube forms a loop large enough for preventing the kinking thereof when the at least one product bag is secured to the support member by the first securing means and the separation bag is secured to the support member by the second securing means.
The second securing means is adapted to secure the separation bag to the support member by a peripheral edge thereof.
The separation bag is substantially annular or semi-annular, and the second securing means is adapted to secure the separation bag to the support member by an inner peripheral edge thereof.
The second securing means is adapted to secure the separation bag to the support member by at least two areas thereof.
The second securing means comprises two spaced apart protruding elements for engaging two apertures in a peripheral area of the separation bag.
The bag assembly further comprises a handle connected to the support member and the two protruding elements extend from the handle.
The first and the second securing means comprise the same two spaced apart protruding elements for engaging two apertures in a peripheral area of the separation bag and two holes in a peripheral area of the at least one product bag.
The bag assembly further comprises a collection bag connected to the separation bag by a transfer tube.
The bag-assembling device further comprises a third securing means connected to the support member for releasably securing the collection bag to the support member.
The support member comprises an elongated body having a first and a second opposite lateral sides, the first securing means comprises two spaced apart protruding elements for engaging two holes in a peripheral area of the at least one product bag, and the third securing means comprises two spaced apart protruding elements for engaging two holes in a peripheral area of the collection bag, whereby the protruding elements of the first securing means extend from the first side of the elongated body and the protruding elements of the second securing means extend from the second side of the elongated body.
The bag-assembling device further comprises a second securing means connected to the support member for releasably securing the separation bag to the support member and a third securing means connected to the support member for releasably securing the collection bag to the support member, whereby the second securing means and the third securing means are so arranged with respect to each other that the transfer tube forms a loop large enough for preventing the kinking thereof when the separation bag is secured to the support member by the second securing means and the collection bag is secured to the support member by the third securing means.
The bag assembly further comprises a filter connected to a tube connected to the at least one product bag.
The bag-assembling device further comprises a holder connected to the support member for releasably holding the filter.
The mounting means and the filter holder are so arranged with respect to each other that the holder is located within the central cavity of a rotor when the bag-assembling device in mounted therein.
The filter has a disk-like housing and the filter holder comprises a cylindrical portion for containing the filter so that the filter and the cylindrical portion of the holder are substantially concentric.
The filter holder is connected to the support member so that a central axis of the cylindrical portion of the holder is substantially perpendicular to a rotation axis of the rotor when the bag-assembling device is mounted in a rotor.
The filter holder and the first securing means are so arranged with respect to each other that the at least one product bag is substantially parallel to one of the circular side of the disk-like housing of the filter.
The bag-assembling device further comprises a first winding support for coiling a portion of a tube connected to the filter.
The bag-assembling device further comprises a second winding support for coiling a collection tube.
The bag assembly further comprises a clamp for selectively closing the product tube connecting the at least one product bag to the separation bag.

According to the invention, a method for manufacturing a bag assembly for the separation of a composite liquid into at least two products comprising the steps of:
Providing bag-assembling device having
   a support member;
   a securing means connected to the support member for releasably securing a plurality of product bags and a separation bag to the support member;
   a filter holder connected to the support member for holding a filter;
   a winding support connected to the support member for coiling a section of tube connected to a filter around or within the winding support;
Inserting a filter connected to two sections of tube into the filter holder;
Coiling one section of the tube connected to the filter around or within the winding support;
Securing a plurality of product bags to the support member by means of the securing means so as to form a stack of the product bags;
Securing a separation bag to the support member by means of the securing means
Connecting one product bag to one section of the tube connected to the filter; and
Connecting each other product bag to the separation bag by a tube so as to form at least one loop of tube large enough to prevent the tube from kinking.

Other features and advantages of the invention will appear from the following description and accompanying drawings, which are to be considered exemplary only.

### BRIEF DESCRIPTION OF DRAWINGS

In the accompanying drawings:

FIG. 1 is a schematic view of a first set of bags for a bag assembly according to the invention;

FIG. 2 is a schematic view of a second set of bags for a bag assembly according to the invention;

FIG. 3 is a perspective view of the upper part of the rotor of a centrifuge adapted to the bag assembly according to the invention;

FIG. 4 is a perspective view (side A) of a first bag-assembling device according to the invention;

FIG. 5 is another perspective view (side B) of the first bag-assembling device according to the invention;

FIG. 6 is a perspective view of a bag assembly comprising the first bag-assembling device, at an earlier stage of its manufacture;

FIG. 7 is a perspective view of the bag assembly of FIG. 6, at a later stage of its manufacture;

FIG. 8 is a perspective view of a second bag-assembling device according to the invention;

FIG. 9 is a perspective view of a bag assembly comprising the second bag-assembling device, at an earlier stage of its manufacture;

FIG. 10 is a perspective view of the bag assembly of FIG. 9, at a later stage of its manufacture;

FIG. 11 is a perspective view of a third bag-assembling device according to the invention;

FIG. 12 is a perspective view of a bag assembly comprising the third bag-assembling device and four bags connected thereto;

FIG. 13 is a schematic perspective view of a fourth bag-assembling device according to the invention;

FIG. 14 is a schematic top view of a bag assembly comprising the fourth bag-assembling device and three bags connected thereto;

FIG. 15 is a perspective view (side A) of a fifth bag-assembling device according to the invention; and

FIG. 16 is another perspective view (side B) of the fifth bag-assembling device according to the invention.

### DETAILED DESCRIPTION

For the sake of clarity, the invention will be described with respect to a specific use, namely the separation of whole blood into a first component comprising plasma, a second component comprising platelets and a third component comprising red blood cell. It should be understood however that this specific use is exemplary only.

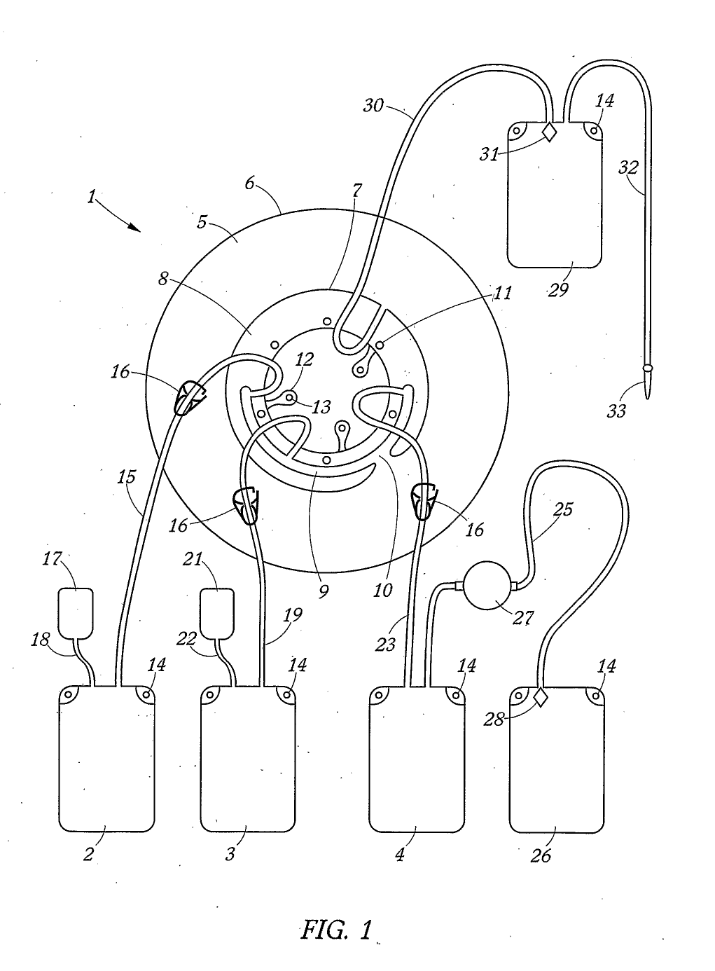

FIG. 1 shows a first example of a set of bags adapted to the separation of whole blood into a plasma product, a platelet product and red blood cell product. This bag set comprises a separation bag 1 and three product bags 2, 3, 4 connected thereto. The separation bag 1 comprises a substantially annular separation chamber 5 having an outer circular edge 6 and an inner circular edge 7, and a disk-shaped connecting element 8 that is connected to the inner edge 7 of the annular chamber 5. The outer circular edge 6 and the inner circular edge 7 of the separation chamber 5 are substantially concentric. The disk-shaped connecting element 8 comprises a substantially semi-circular distribution channel 9 embedded therein, which communicates through a passage 10 with the annular chamber 5. The disk-shaped connecting element 8 further comprises a series of holes 11 for connecting the separation bag 1 to the rotor of a centrifuge. Three peripheral tongues 12 having an aperture 13 therethrough are attached to the inner periphery of the disk-shaped connecting element 8 for fastening the separation bag 1 to a bag-assembling device that will be later described.

Variants of the separation bag 1 may include:
a separation chamber 5 having an outer circular edge 6 and an inner circular edge 7 that are eccentric;
a separation chamber 5 having one or two radial walls extending from the inner edge 7 to the outer edge 6 so that the chamber, instead of being annular, has a C-shape with the C being more or less open.

Also the separation bag 1 can be shaped so as to fit either on a flat support surface or on a frusto-conical support surface of the rotor of a centrifuge.

The first product bag 2 is intended for containing the platelet product. It is flat and substantially rectangular and comprises a hole 14 at each of its upper corners for fastening the product bag 2 to a bag-assembling device (described hereunder). It is connected by a first product tube 15 to the separation bag 1. The first product tube 15, which is fitted with a clamp 16, has a first end connected to the upper edge of the first product bag 2 and a second end connected to a first end of the distribution channel 9. A first bag 17 for purging air is connected by a tube 18 to the upper edge of the first product bag 2.

The second product bag 3 is intended for containing the plasma product. It is flat and substantially rectangular and comprises a hole 14 at each of its upper corners for fastening the product bag 3 to a bag-assembling device (described hereunder). It is connected by a second product tube 19 to the separation bag 1. The second product tube 19, which is fitted with a clamp 16, has a first end connected to the upper edge of the second product bag 3 and a second end connected to the distribution channel 9, between the end of the first product tube 15 connected thereto and the passage 10 between the distribution channel 9 and the annular chamber 5. A second bag 21 for purging air is connected by a tube 22 to the upper edge of the second product bag 3.

The third product bag 4 is intended for containing the red blood cell product. It is flat and substantially rectangular and comprises a hole 14 at each of its upper corners for fastening the product bag 4 to a bag-assembling device (described hereunder). It is connected by a third product tube 23 to the separation bag 1. The third product tube 23, which is fitted with a clamp 16, has a first end connected to the upper edge of the third product bag 4 and a second end connected to a second end of the distribution channel 9.

The third product bag 4 is connected by a transfer tube 25 to an auxiliary product bag 26, which is flat, substantially rectangular and comprises a hole 14 at each of its upper corners for fastening the auxiliary product bag 26 to a bag-assembling device (described hereunder). The transfer tube 25 has a first end connected to the upper edge of the third product bag 4 and a second end connected to the upper edge of the auxiliary product bag 26. It has two segments respectively connected to the inlet and the outlet of a leukoreduction filter 27 (a filter for removing white blood cells). The auxiliary bag 26 contains a volume of storage solution for red blood cells. A plug 28 removable from within the auxiliary product bag 26 (so-called “frangible pin”, for example) blocks a liquid flow through the transfer tube 25 and prevents the storage solution from flowing from the auxiliary product bag 26 into the third product bag 4. Alternatively, the auxiliary bag 26 does not contain a storage solution, and is fitted with a port connected to a sterile filter, through which a storage solution can be injected within the auxiliary bag 26 just before the red blood cells are transferred from the third product bag into the auxiliary bag 26.

The bag set further comprises a collection bag 29, which is intended for receiving a volume of whole blood from a donor (usually about 450 ml). The collection bag 29 is flat, substantially rectangular and comprises a hole 14 at each of its upper corners for fastening the collection bag 29 to a bag-assembling device (described hereunder). The collection bag 29 is connected to the separation bag 1 by a transfer tube 30 having one end attached to the upper edge of the collection bag 29 and the other end attached at the inner edge 7 of the annular chamber 5. The collection bag 29 contains a volume of anti-coagulant solution (typically about 70 ml of a solution of citrate phosphate dextrose for a blood donation of about 450 ml). A plug 31 removable from within the collection bag 29 (so-called “frangible pin”, for example) blocks a liquid flow through the tube 30 and prevents the anti-coagulant solution from flowing from the collection bag 29 into the separation bag 1.

The bag set further comprises a collection tube 32 that is connected at one end to the upper edge of the collection bag 29 and comprises, at the other end, a needle protected by a sheath 33.

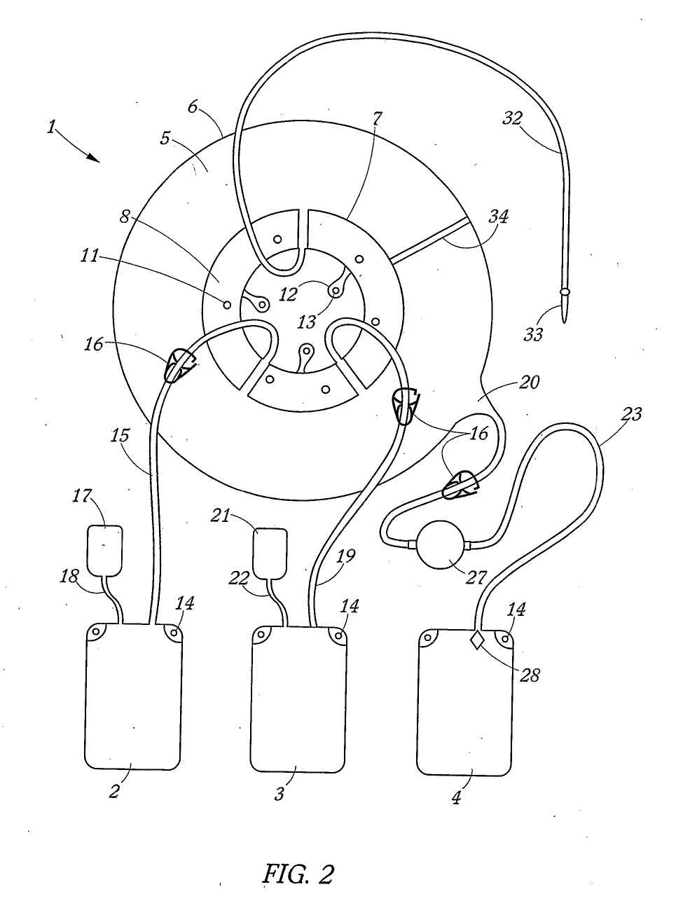

FIG. 2 shows a second example of a set of bags adapted to the separation of whole blood into a plasma product, a platelet product and red blood cell product. This bag set comprises a separation bag 1 and three product bags 2, 3, 4 connected thereto. The separation bag 1 comprises a partially annular separation chamber 5 having a substantially circular outer edge 6, an inner circular edge 7 and a radial wall 34 extending from the inner edge 7 to the outer edge 6 so that the chamber 5 has a shape of a broken ring. The separation chamber 5 also comprises a funnel like extension 20 protruding outwardly from its outer edge 6 for helping evacuate a content of the separation chamber into a third product bag 4 to be described hereunder. The separation bag 1 further comprises a disk-shaped connecting element 8 that is connected to the inner edge 7 of the annular chamber 5. The disk-shaped connecting element 8 comprises a series of holes 11 for connecting the separation bag 1 to the rotor of a centrifuge. Three peripheral tongues 12 having an aperture 13 therethrough are attached to the inner periphery of the disk-shaped connecting element 8 for fastening the separation bag 1 to a bag-assembling device (described hereunder).

The first product bag 2 is intended for containing the platelet product. It is flat and substantially rectangular and comprises a hole 14 at each of its upper corners for fastening the product bag 2 to a bag-assembling device (hereunder described). It is connected by a first product tube 15 to the separation bag 1. The first product tube 15, which is fitted with a clamp 16, has a first end connected to the upper edge of the first product bag 2 and a second end connected to the inner edge 7 of the annular chamber 5. A first bag 17 for purging air is connected by a tube 18 to the upper edge of the first product bag 2.

The second product bag 3 is intended for containing the plasma product. It is flat and substantially rectangular and comprises a hole 14 at each of its upper corners for fastening the product bag 3 to a bag-assembling device (described hereunder). It is connected by a second product tube 19 to the separation bag 1. The second product tube 19, which is fitted with a clamp 16, has a first end connected to the upper edge of the second product bag 3 and a second end connected to the inner edge 7 of the annular chamber 5. A second bag 21 for purging air is connected by a tube 22 to the upper edge of the second product bag 3.

The third product bag 4 is intended for containing the red blood cell product. It is flat and substantially rectangular and comprises a hole 14 at each of its upper corners for fastening the product bag 4 to a bag-assembling device (described hereunder). It is connected by a third product tube 23 to the separation bag 1. The third product tube 23, which is fitted with a clamp 16, has a first end connected to the upper edge of the third product bag 4 and a second end connected to the tip of the funnel like extension 20 of the separation chamber 5. It comprises two segments respectively connected to the inlet and the outlet of a leukoreduction filter 27 (a filter for removing white blood cells). The third product bag 4 contains a volume of storage solution for red blood cells. A plug 28 removable from within the third product bag 4 (so-called “frangible pin”, for example) blocks a liquid flow through the product tube 23 and prevents the storage solution from flowing from the third product bag 4 into the separation bag 1.

The bag set further comprises a collection tube 32 that is connected at one end to the inner edge 7 of the separation bag 1 and comprises, at the other end, a needle protected by a sheath 33.

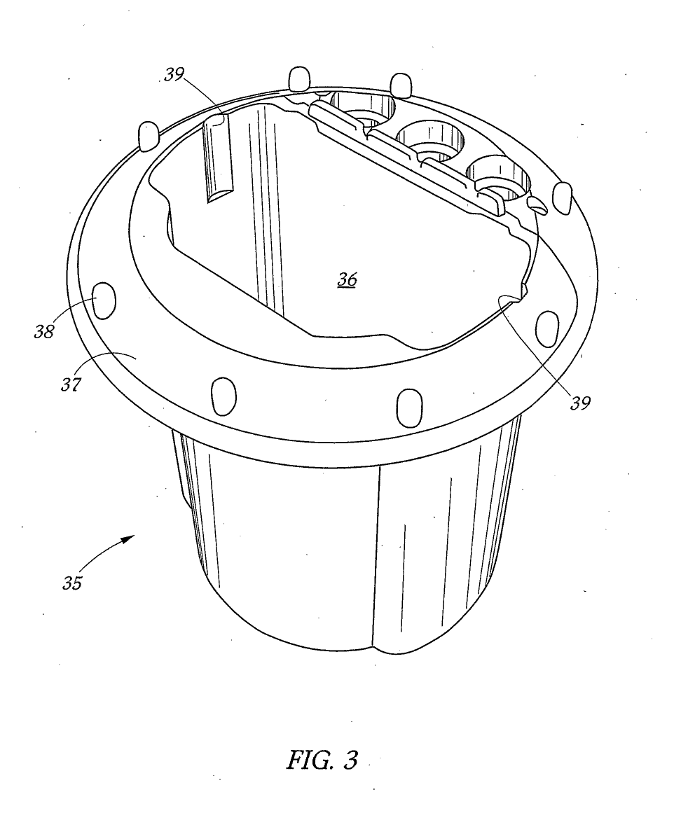

FIG. 3 shows the central portion of the upper part of the rotor 35 of a centrifuge used for the separation a volume of blood into a plasma product, a platelet product and a red blood cell product. The central portion of this rotor 35 comprises a central container 36 intended for receiving the product bags 2, 3, 4, 26 and the filter 27 during the separation process. It further comprises an annular flange 37, connected to the upper rim of the container 36, for supporting the disk-shaped connecting element 8 of a separation bag 1. The annular flange 37 is fitted with a series of rounded pins 38 for engaging the holes 11 in the connecting element 8 of the separation bag 1 so as to prevent the separation bag 1 from moving with respect to the rotor during the centrifugation thereof. The rotor 35 also comprises a mounting means for cooperating with a complementary mounting means of a bag-assembling device of the invention, which will be described hereunder. The mounting means of the rotor 35 comprises two slots 39 that are recessed within the wall of the container 36. The slots 39 are substantially equidistant with respect to and in the same plane as the rotation axis of the rotor 35.

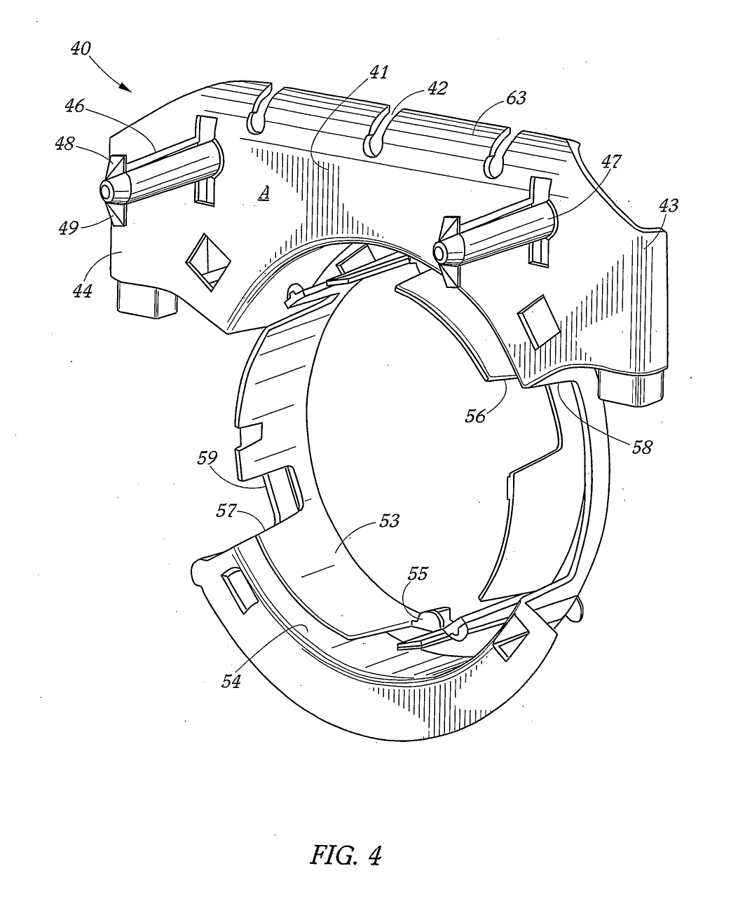

FIGS. 4 to 16 show five embodiments of a bag-assembling device according to the invention. The bag-assembling device has three main purposes: first, it is used, during the manufacture of the set of bags, for assembling in a determined order the product bags 2, 3, 4, 26 and the collection bag 29 to the separation bag 1; second, it is used, during the sterilization of the bags once connected together by the various tubes, for maintaining the bags in a fixed relationship with respect to each other so that the loops, formed in the tubes during the assembling stages, keep their curvature and the tubes do not run the risk of kinking; third, it is used, during the use of the bag assembly as a final product, for quickly loading and unloading the set of bags in the rotor 35 of a centrifuge, and for keeping the product bags 2, 3, 4, 26 in a determined position within the container 36 of the rotor 35 during the spinning thereof.

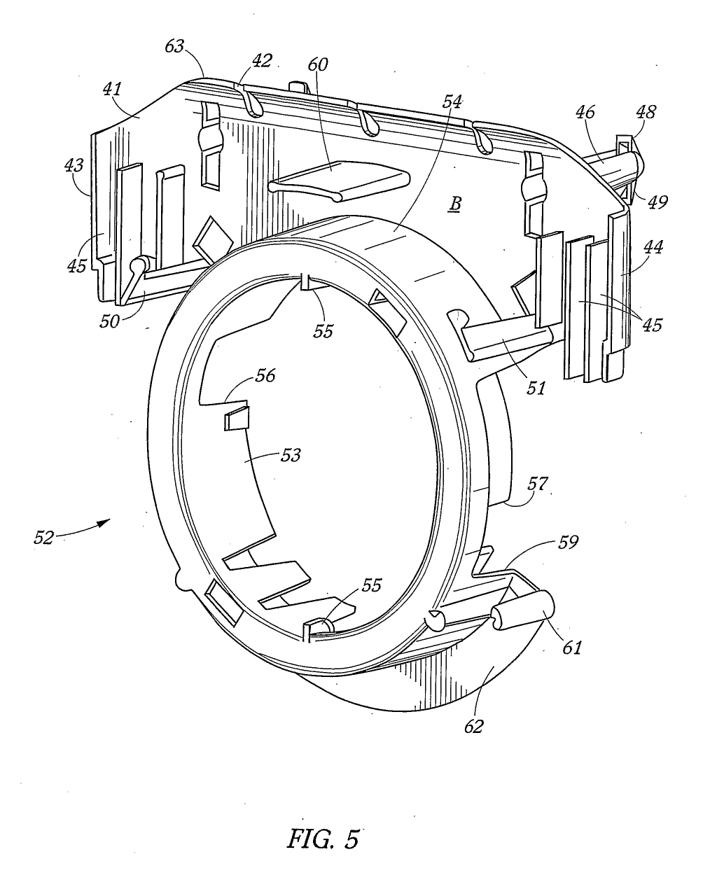

FIGS. 4 and 5 represent the two sides A and B of a first embodiment of a bag-assembling device 40 according to the invention. The bag-assembling device comprises a support member 41 having an elongated flat body connected to an upper ridge 63 that is bent. Three slits 42 are cut out in the bent ridge 63 for guiding the product tubes 15, 19, 23.

The bag-assembling device 40 further comprises a mounting means having two extensions 43, 44 connected to the lateral edges of the elongated flat body 41. The outer rims of the extensions 43, 44 are bent so as to be perpendicular to the elongated flat body 41. The extensions 43, 44 are fitted respectively with one or two gutter-like holders 45 parallel to their outer rims, in which a portion of tube or the needle sheath 33 can be snuggly engaged. The mounting means is for removably mounting the bag-assembling device 40 in the rotor 35 represented in FIG. 3. The shape of the extensions 43 and 44 is complementary of the shape of the slots 39 in the upper part of the wall of the container 36, so that they can be engaged thereto and form therewith a tongue-and-groove arrangement. When the bag-assembling device 40 is mounted in the rotor 35, the support member 41 is substantially located within the container 36, it extends across the aperture of the container 36, and perpendicularly intersects the rotation axis of the rotor 35.

The bag-assembling device 40 further comprises a first securing means connected to the support member 41 for releasably securing the product bags 2, 3, 4, 26 to the support member 41. The first securing means is comprised of two spaced apart protruding elements in the form of rods 46, 47 that perpendicularly extend from the side A of the elongated body 41, just beneath the bent upper ridge 63 thereof. The distance between the two rods 46, 47 is substantially the same as the distance between the holes 14 in the upper part of the product bags 2, 3, 4, 26. The cross-section of the rods 46, 47 substantially fits in the holes 14. The tip of each rod 46, 47 is fitted with an upper and a lower barbs 48, 49 for preventing a bag engaged on the rod from escaping therefrom during centrifugation of the bag assembly. The upper barb 48, which extends upwardly, is smaller than the lower barb 49, which extends downwardly, so as to facilitate the engagement of the rod 46, 47 in a hole 14 of a bag.

It results from the respective arrangement of the mounting means 43, 44 and the first securing means 46, 47 that the product bags 2, 3, 4, 26 occupy a determined position in the central cavity of a rotor when the assembling device and the bags secured thereto are mounted in the rotor. More specifically, when mounted in the rotor 35 represented in FIG. 3, the bags 2, 3, 4, 26 are very close to the rotation axis of the rotor so that the centrifugal forces exerted on the content of these bags during the separation process is minimal. This is of particular interest for a platelet product, which consists of platelets suspended in plasma, since the platelets tend to agglutinate when subjected to substantial centrifugation forces.

The bag-assembling device 40 further comprises a second securing means connected to the support member 41 for releasably securing a separation bag 1 thereto. In the embodiment of the bag-assembling device 40 represented in the FIGS. 4, 5, 6, 7, the second securing means is also comprised of the two spaced apart rods 46, 47 that form the first securing means. Alternatively, the second securing means may be comprised of separate protruding elements. The use of the rods 46, 47 as a second securing means requires that the three tongues 12 extending from the inner periphery of the disk-shaped connecting element 8 of the bag 1 (in FIGS. 1 and 2) are arranged as follows: first, the tongues 12 are spaced apart around the inner periphery of the disk-shaped connecting element 8 so that the separation bag 1 can be folded in two along a diameter and two of the tongues 12 are superposed; second, the distance between the holes 13 in the two superposed tongues 12 and the hole 13 in the third tongue 12 is substantially the same as the distance between the rods 46, 47.

The second securing means is useful during the sterilization and the subsequent manipulation and shipping of the bag assembly (i.e. the set of bags of the FIG. 1 or 2 secured to the bag-assembling device 40), since it keeps the separation bag 1 in a fixed position with respect to the product bags 2, 3, 4, 26 and allows for bending the various tubes interconnecting them in substantially stable loops so that the kinking of the tubes is prevented. Note that this result could also be achieved by placing the bag assembly, with only the product bags 2, 3, 4, 26 secured to the bag-assembling device 40, in a package so shaped as to keep the separation bag 1 in a fixed position with respect to the product bags 2, 3, 4, 26.

The bag-assembling device 40 further comprises a third securing means connected to the support member 41 for releasably securing the collection bag 25 thereto. The third securing means is comprised of two spaced apart protruding elements in the form of hooked pegs 50, 51 that perpendicularly extend from the side B of the elongated plate 41, just above the lower ridge thereof. The distance between the two pegs 50, 51 is substantially the same as the distance between the holes 14 in the upper part of the collection bag 29.

It results from the respective arrangement of the second securing means (rods 46, 47) and of the third securing means (pegs 50, 51) that the transfer tube 30 can be bent so as to form a loop large enough for preventing the kinking thereof when the separation bag 1 is secured to the support member 41 by the second securing means 46, 47 and the collection bag 29 is secured to the support member 41 by the third securing means (50, 51).

The bag-assembling device 40 further comprises a holder 52 connected to the support member 41 for releasably holding a filter 27 having a generally disk-shaped casing and diametrically opposed radial inlet and outlet. The holder 52 comprises a tubular section 53 having an internal diameter slightly larger than the diameter of the casing of the filter 27 and a width larger that the thickness of the filter 27. The tubular section 53 is connected to a concentric, larger tubular section 54 of the same width, which, in turn is connected to the lower edge of the elongated plate 41. The tubular sections 53, 54 are connected by one of their rims, their other rims are flush with the side A of the elongated body 41 and their central axis is perpendicular to the elongated body 41.

It results from the relative arrangement of the support member 41, the mounting means 43, 44 and the filter holder 52, that the holder 52 is located within the container 36 of the rotor 35, when the bag-assembling device 40 in mounted therein.

It results from the relative arrangement of the support member 41, the first securing means 46, 47, the third securing means 50, 51 and the filter holder 52, that the product bags 1, 2, 3, 26 and the collection bag 29 hang parallel to each other and to the circular sides of the filter 27, when the bag assembly is mounted within the rotor 35 of a centrifuge.

The tubular section 53 of the filter holder 52 is fitted with two stops 55 protruding inwardly so as to keep the filter 27 in a middle position within the tubular section 53. Since, as mentioned above, the thickness of the filter 27 is less that the width of the tubular section 53, the filter 27 does not contact the closest product bag and the collection bag; this disposition is of particular interest when the plastic material (e.g. PVC) of which the bags are made and the plastic material (e.g. polycarbonate) of which the casing of the filter 27 is made have a tendency to fuse together when in contact during a steam sterilization process.

The tubular section 53 of the filter holder 52 further comprises two diametrically opposed cut-outs 56, 57 for respectively allowing the two sections of the transfer tube 25 (product tube 23, in FIG. 2) connected to the inlet and to the outlet of the filter 27 to extend out of the filter holder 52. The larger tubular portion 54 also comprises two diametrically opposed cut-outs 58, 59 for the same purpose.

The bag-assembling device 40 further comprises a first winding support for coiling the downstream portion of the transfer tube 25 (product tube 23, in FIG. 2) connected to the outlet of the filter 27. The first winding support comprises the tubular gap defined between the outer surface of the smaller tubular section 53 and the inner surface of the larger tubular section 53.

The bag-assembling device further comprises a second winding support for coiling the collection tube 32. The second winding support comprises the larger tubular section 53 and several protruding guides arranged around its outer surface, namely: the two pegs 50, 51 of the third securing means, a tongue 60 perpendicularly protruding from the middle of the side B of the support member 41, and a pin 61 adjacent the cut-out 59, which is connected to a flange 62 extending downward from the rim of the larger tubular section 53 that is flush with the side A of the elongate body 41.

The bag-assembling device 40 described above can be manufactured in one piece by injection molding of a plastic material like polypropylene. A bag assembly comprising the bag set represented in FIG. 1 and the bag-assembling device 40 is manufactured as follows.
The disk-shaped filter 27 to which the two sections of the transfer tube 25 have been previously connected is inserted in the filter holder 52.
The downstream section of the transfer tube 25, which is connected to the outlet of the filter 27, is coiled within the first winding support (annular gap between the tubular sections 53 and 54).
The platelet product bag 2, to which the first air-purging bag 17 has been previously connected, is engaged on the two rods 46, 47 of the first securing means.
The plasma product bag 3, to which the second air-purging bag 21 has been previously connected, is engaged on the two rods 46, 47 of the first securing means so as to stack against the platelet product bag 2. The first air purging bag 17 is inserted between the platelet product bag 2 and the plasma product bag 3 so that the tube 18 forms a large loop.
The primary red blood cell product bag 4 is engaged on the two rods 46, 47 of the first securing means so as to stack against the plasma product bag 3. The second air purging bag 21 is inserted between the plasma product bag 2 and the primary red blood cell product bag 4 so that the tube 22 forms a large loop.
The auxiliary red blood cell product bag 26 is engaged on the two rods 46, 47 of the first securing means so as to stack against the primary red blood cell product bag 4.
The separation bag 1, to which the product tubes 15, 19, 23 and the transfer tube 30 have been previously connected, is engaged on the two rods 46, 47 of the second securing means so as to stack against the auxiliary red blood cell product bag 26.
The free end of each product tube 15, 19, 23 is bonded to the upper edge of the corresponding product bag 2, 3, 4. The free ends of the upstream and downstream sections of the transfer tube 25 are respectively bonded to the upper edge of the primary red blood cell product bag 4 and of the auxiliary red blood cell product bag 26. As a result of the relative fixed positions of the filter 27, the product bags 2, 3, 4, 26, and the separation bag 1, the various tubes connecting them can be arranged so as to form large loops unlikely to kink during the sterilization of the bag assembly and the subsequent manipulations and shipping.
The collection bag 29 is engaged on the two pegs 50, 51 of the third securing means.
The collection tube 32 is coiled around the second winding support 53 and its free end is bonded to the upper edge of the collection bag 29. The free end of the transfer tube 30 is bonded to the upper edge of the collection bag 29. Here also, as a result of the relative fixed positions of the collection bag 29 and the separation bag 1, the collection tube 32 and the transfer tube 30 can be arranged so as to form large loops unlikely to kink during the sterilization of the bag assembly and subsequent manipulations and shipping.
A volume of anticoagulant solution is injected into the collection bag 29 and a volume of storage solution is injected into the auxiliary red blood cell bag 26.
The bag assembly may be inserted in a first package and steam sterilized.
After sterilization the (packaged) bag assembly is enclosed in a (second) gas-tight package so as to prevent the evaporation of the anticoagulant solution from the collection bag 29 and have the storage solution from the auxiliary bag 26.

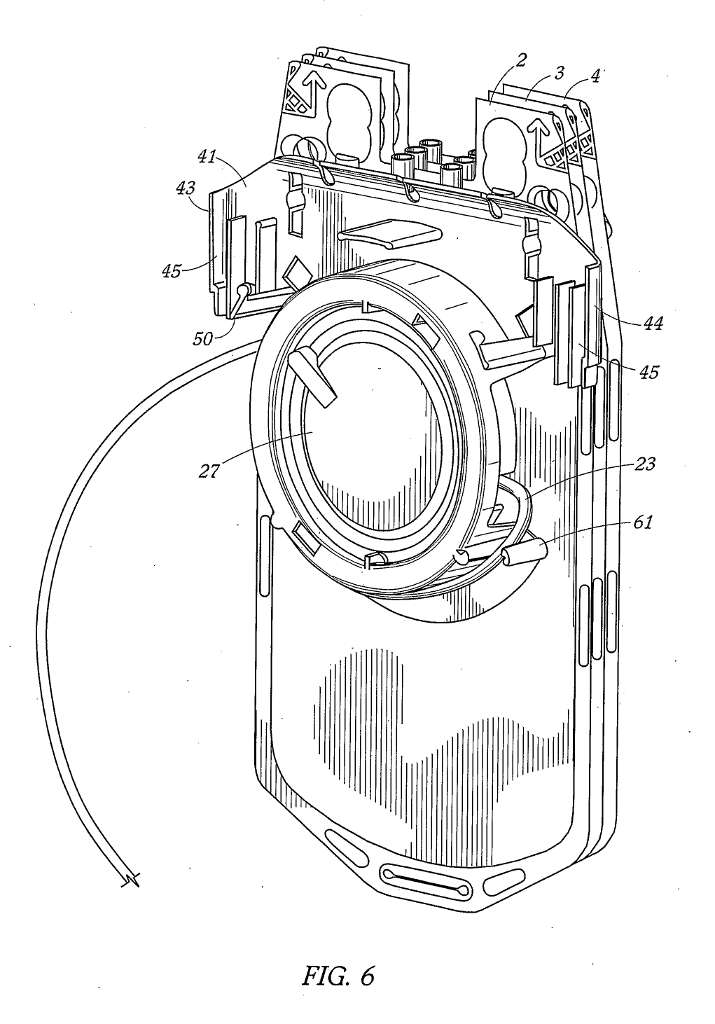

FIGS. 6 and 7 show two stages of the manufacture of a bag assembly comprising the bag-assembling device of FIGS. 4 and 5 and the bag set of FIG. 2.

In FIG. 6, the disk-shaped filter 27 has been inserted in the filter holder 52 and the downstream section of the product tube 23, which is connected to the outlet of the filter 23, has been coiled within the first winding support (annular gap between the tubular sections 53 and 54); also the three product bags 2, 3, 4 have been engaged on the two rods 46, 47 of the first securing means.

In FIG. 7, the separation bag 1 has been engaged on the two rods 46, 47 so as to stack against the product bags 2, 3, 4; the free end of each product tube 15 and 19 has been bonded to the upper edge of the corresponding product bag 2 and 3; the ends of the product tube 23 have been respectively bonded to the upper edge of the third product bag 4 and to the funnel like extension 20 of the separation bag 1; finally, the collection tube 32 has been coiled around the second winding support 54 and the needle within the needle sheath 33 at the end of the collection tube 32 has been engaged in the needle holder 45.

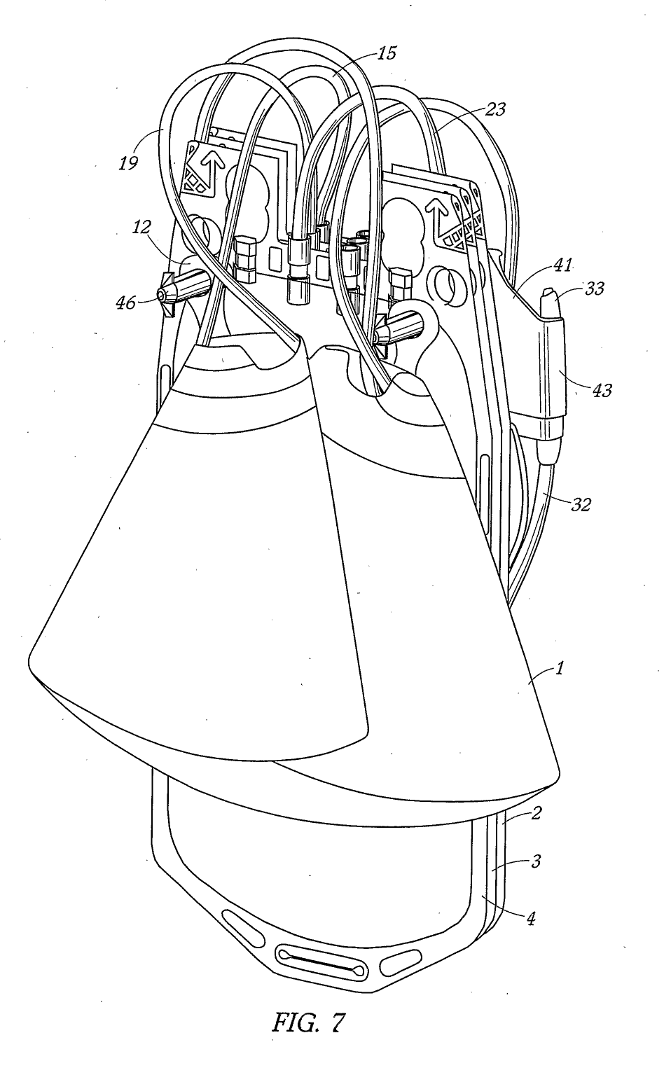

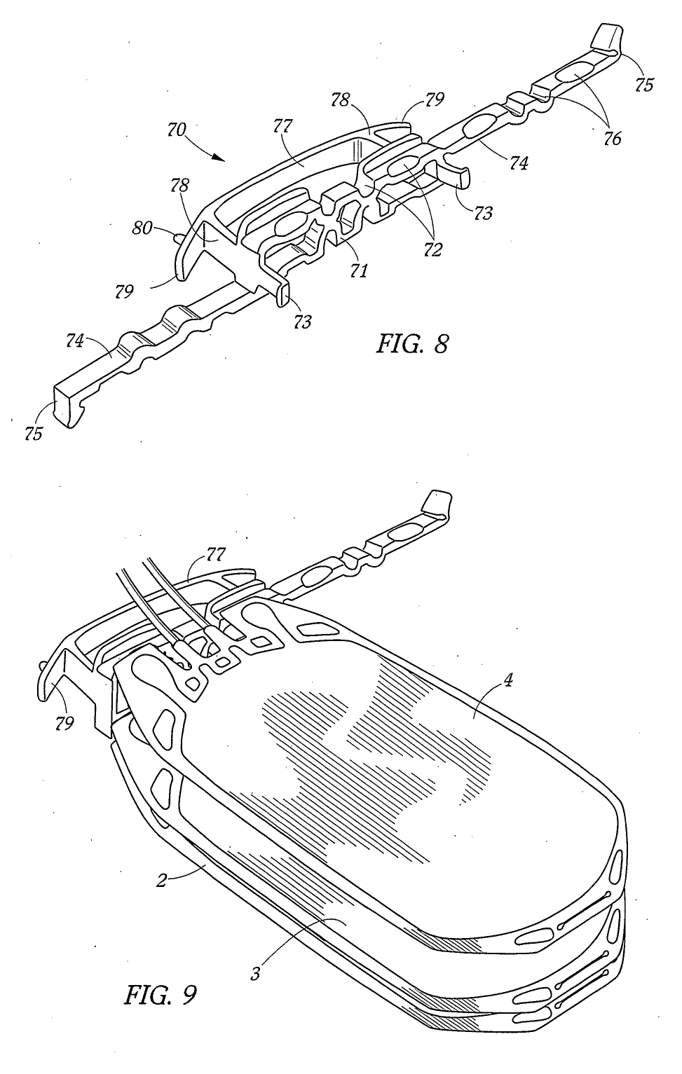

FIGS. 8, 9 and 10 show a second embodiment of a bag-assembling device 70 according to the invention. The bag-assembling device 70 comprises an elongated support member 71 having two lateral sides that are identical. Each side is generally flat except for an upper rim and a series of recesses 72 corresponding to the two tubes and the two sampling ports connected to the upper edge of a product bag.

The bag-assembling device 70 further comprises a mounting means for removably mounting the bag-assembling device to the rotor of a centrifuge. The mounting means is comprised of two resilient snap lock legs 73 that protrude downwards at each end of the support member 71.

The bag-assembling device 70 further comprises a first securing means for releasably securing to the support member 71 at least one product bag. The first securing means is comprised of two jaws 74 that are hinged at one end of each lateral side of the support member 71 and are fitted at their other end with a snap lock grip 75 by which they can be releasably fastened in a closed position to the support member 71. Each jaw 74 comprises recesses 76 that are symmetrical to the recesses 72 in the lateral sides of the support member 71. Each jaw 74 can secure one or two product bags to the support member 71.

The bag-assembling device 70 further comprises a handle 77 that extends above the support member 71 and is fastened thereto by two studs 78 that are aligned with the legs 73 of the mounting means. The purpose of this handle 77 is to facilitate the mounting and the withdrawal of a bag assembly in and from the rotor of a centrifuge.

The bag-assembling device 70 further comprises a second securing means connected to the support member 71 for releasably securing the separation bag 1 thereto. The second securing means comprises two lateral arms 79 extending from the ends of the handle 77 and two pins 80 protruding upwards from the lateral arms 79. The size and the distance between the two pins 80 correspond to a couple of holes 11 in the disk-shaped connecting element 8 of a separation bag 1.

One of the jaws 74 can be used to secure a collection bag 29 to the support member 71 and perform the function of the third securing means described above in reference to the FIGS. 4 to 7.

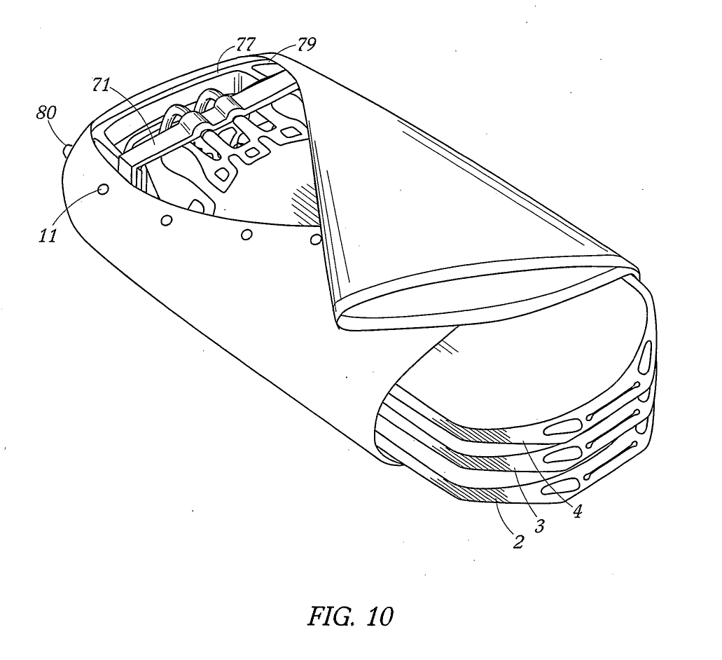

FIGS. 9 and 10 show a bag assembly including the bag-assembling device 70 and the bag set of FIG. 2 at two stages of its manufacture. In FIG. 9, two product bags 2, 3 have been secured to the support member 71 by one of the jaws 74, and a third product bag 4 is in place for being secured in turn to the support member 71 by the other jaw 74. In FIG. 10, the product bags 2, 3, 4 are connected to the separation bag 1, which is secured to the support member 71 by the two pins 80 and wrapped around the products bags. In this embodiment, the filter 27 is not secured to the support member 71 and is simply inserted between the product bags 2, 3, 4.

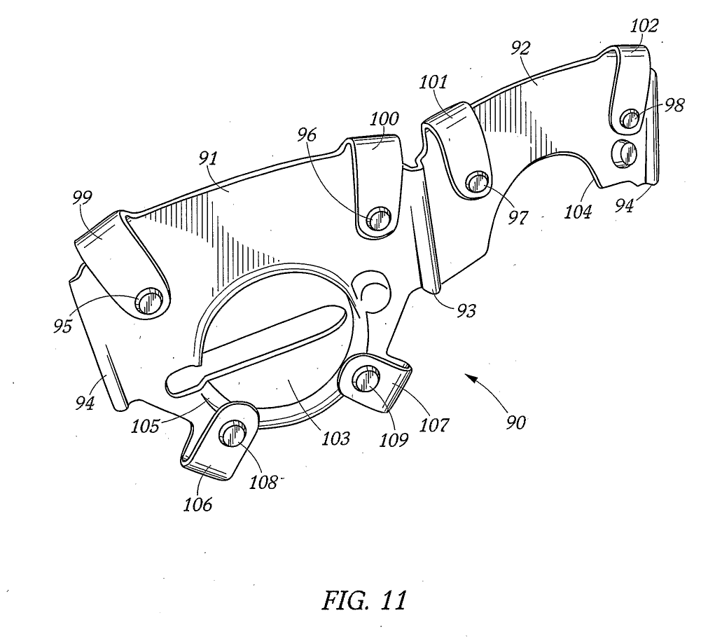

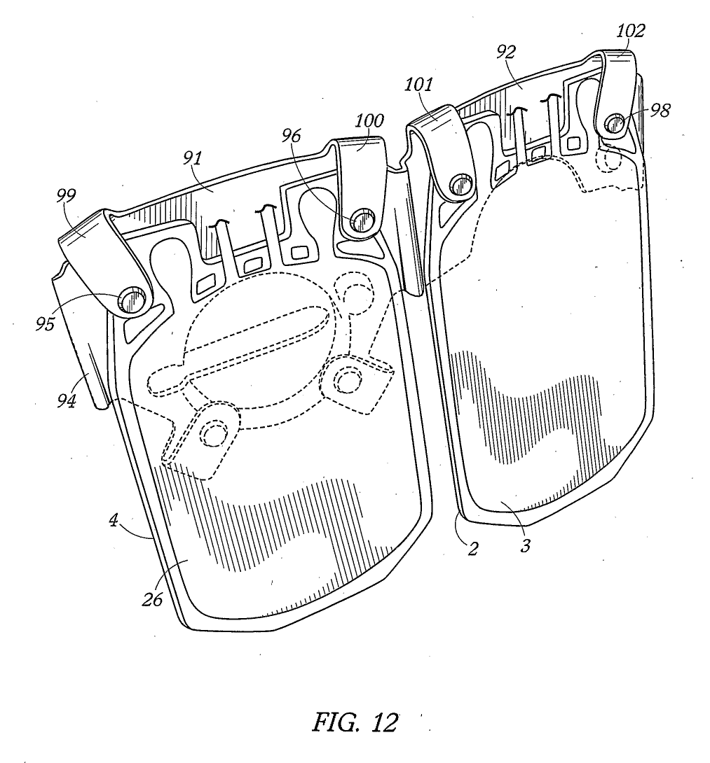

FIGS. 11 and 12 show a third embodiment of a bag-assembling device 90 according to the invention. The bag-assembling device 90 comprises a support member including two substantially flat flaps 91, 92 connected together by a hinge 93 that laterally protrudes.

Each flap comprises a lateral edge 94 parallel to the hinge 93, which is so designed that, when the two flaps 91, 92 are pressed against each other, the two lateral edges 94 have substantially the same shape as the hinge 93. In this embodiment of the invention, the mounting means by which the bag-assembling device 90 can be mounted in the rotor of a centrifuge is comprised of the hinge 93 and the two lateral edges 94 pressed against each other.

The bag-assembling device 90 further comprises a first securing means connected to the support member 91, 92 for releasably securing at least one product bag to the support member. The first securing means comprises two couples of spaced apart knobs 95, 96 and 97, 98 respectively connected to the outer surface of the flaps 91, 92, close to the upper edge thereof. The distance between the knobs 95, 96 and 97, 98 on each flap 91, 92 substantially corresponds to the distance between the two holes 14 at the upper edge of a product bag 2, 3, 4, 26. The first securing means also comprises four flexible straps 99, 100, 101, 102 corresponding to the knobs 95, 96, 97, 98. Each strap has one end connected to the upper edge of one of the flaps 91, 92 and another end fitted with a hole through which the corresponding knob can be forcibly engaged so as to prevent a bag engaged on the knob from escaping therefrom.

The bag-assembling device 90 further comprises a disk-shaped filter holder 103 that is integral with one of the flap 91 and recessed from the outer surface thereof. The other flap 92 comprises a cut-out 104 partially corresponding to the filter holder 103 so that, when the two flaps 91, 22 are pressed against each other their respective inner surfaces are in contact with each other.

The bag-assembling device 90 further comprises a winding support for coiling a section of the tube connected to a filter. The winding support comprises an annular rim 105 protruding from the outer surface of the flap 91 around the filter holder 103, and a means for releasably binding a coil of tube wound around the annular rim 105. The binding means comprises two flexible straps 106, 107 having one end connected to the lower edge of the flap 101 and having an other end fitted with a hole for forcibly engaging two knobs 108, 109 connected to the flap 91 close to the annular rim 105 of the winding support.

In addition to being used for securing products bags 2, 3, 4, 26 to the flaps 91, 92, each of the couple of knobs 95, 96 and 97, 98 can be used to secure a separation bag 1 and a collection bag 29 to the flaps 91, 92 and perform then the function of the second and third securing means described above in reference to the FIGS. 4 to 7.

In FIG. 12, two products bags 2, 3 and 4, 26 are secured to each flap 91, 92 of the bag-assembling device 100.

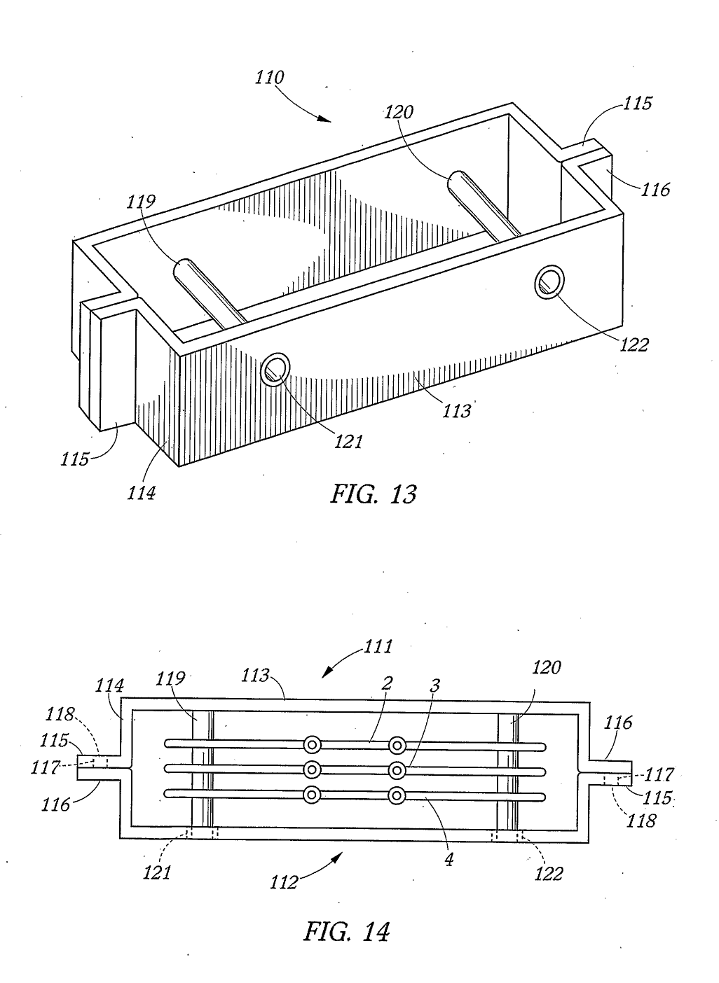

FIGS. 13 and 14 show a fourth embodiment of a bag-assembling device 110 according to the invention. The bag-assembling device 110 comprises a support member including two substantially identical U-shaped elements 111, 112 that are releasably connectable so as to define therebetween an oblong gap. Each U-shaped element comprises a straight flat base 113, two straight flat arms 114 perpendicularly connected to the base 113 at each end thereof of, and two connecting ears 115, 116 extending outwardly from the upper end of each arm 114. One of the connecting ears 115 comprises a hole 117 in the middle thereof and the other connecting ear 116 comprises a pin 118 in the middle thereof protruding outwardly and having a shape complementary to the shape of the hole 117 in the other connecting ear. The two identical U-shaped elements 111 and 112 of the support member can be connected by engaging the pin 118 of one U-shaped element 111, 112 in the hole 117 of the other U-shaped element 111, 112. The two ears 115, 116 connected to each other at both lateral ends of the support member form a mounting means by which the bag-assembly 110 can be removably mounted in a rotor of a centrifuge.

The bag assembling device 120 further comprises a bag-securing means in the form of two spaced apart rods 119, 120 perpendicularly connected to the base of one of the U-shaped elements 111 so as to extend across the gap within the U-shaped elements 111, 112. The distance between the rods 119, 120 is substantially equal to the distance between two securing holes 11, 13, 14 of any bag of a bag assembly. The rods 119, 120 are slightly longer than the width of the gap between two connected U-shaped elements 111, 112, and the U-shaped element 112 comprises two holes 121, 122 in its base 113 for receiving the tip of the rods 119, 120 protruding from the other U-shaped element 111.

In this embodiment of the bag-assembling device of the invention, the two rods 119, 120 can perform the function of the first, second and third securing means described above in reference to the FIGS. 4 to 7.

The bag-assembling device 110 is adapted to hold stacked to each other all the bags of a bag set. In FIG. 14, the products bags 2, 3, 4 of the bag set of FIG. 2 are shown engaged on the rod 119, 120 of the bag-assembling device.

The bag-assembling device 110 does not comprise a holder for a filter 27, and the filter 27 simply hangs within the central cavity of the rotor when the bag assembly is mounted therein.

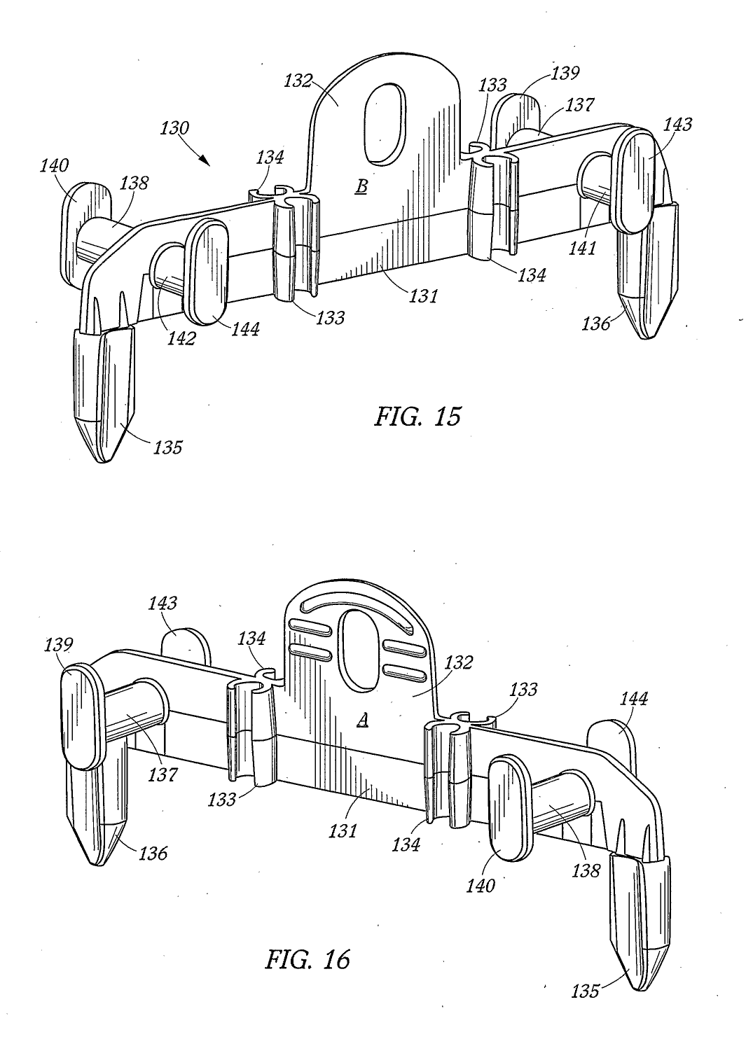

FIGS. 15 and 16 represent the two sides A and B of a fifth embodiment of a bag-assembling device 130 according to the invention. The bag-assembling device 130 comprises a support member having an elongated flat body 131. A flat U-shaped handling appendage 132 is connected to the elongated body 131 in the middle thereof so as to protrude upwardly when the bag-assembling device 130 is mounted in the rotor of a centrifuge. The elongated flat body 131 is fitted on both sides A and B with two parallel gutter-like holders 133, 134 that are perpendicular to a longitudinal axis of the elongated flat body 131 and extend in a central portion of the elongated flat body 131, substantially in alignment with the lateral edges of the U-shaped handling appendage 132, respectively. The gutter-like holders 133, 134 are so dimensioned that a portion of tube or the needle sheath 33 can be snuggly engaged therein.

The bag-assembling device 130 further comprises a mounting means for removably mounting the bag-assembling device 130 in the rotor of a centrifuge. The mounting means comprises two fang-like extensions 135, 136 connected to both ends of the elongated flat body 131 so as to protrude downwardly when the bag-assembling device 130 is mounted in the rotor of a centrifuge. This mounting means is used when the central container of the rotor of a centrifuge, like in FIG. 3, comprises two diametrally opposed slots or recesses for receiving the fang-like extensions 135, 136.

The bag-assembling device 130 further comprises a first securing means connected to the support member 131 for releasably securing the product bags 2, 3, 4, 26 to the support member 131. The first securing means is comprised of two spaced apart protruding elements in the form of rods 137, 138 that perpendicularly extend from the side A of the elongated body 131. The distance between the two rods 137, 138 is substantially the same as the distance between the holes 14 in the upper part of the product bags 2, 3, 4, 26. The cross-section of the rods 137, 138 substantially fits in the holes 14. The tip of each rod 137, 138 is fitted with a retaining element 139, 140 for preventing a bag engaged on the rod from escaping therefrom during centrifugation of the bag assembly. Each retaining element 139, 140 is comprised of a plate having rounded ends that is perpendicularly connected to the corresponding rod 137, 138 in such a way that the portion of the plate that extends upwardly is longer the portion of the plate that extends downwardly when the bag-assembling device 130 is mounted in the rotor of a centrifuge.

Alternatively, the first securing means 137, 138, 139, 140 also performs the function of the mounting means described above, when the central container of the rotor comprises a portion of wall that is substantially flat and has two slots or recesses so shaped and positioned as to receive and lock the tip of the rods 137, 138. When the tips of the rods 137, 138 are engaged in the two recesses, the support member 131 substantially extends in parallel to the flat wall of the central container of the rotor.

It results from the respective arrangement of the mounting means 135, 136 and the first securing means 137, 138, 139, 140 that the product bags 2, 3, 4, 26 occupy a determined position in the central cavity of a rotor when the assembling device and the bags secured thereto are mounted in the rotor.

The bag-assembling device 130 further comprises a second securing means connected to the support member 131 for releasably securing a separation bag 1 thereto. In the embodiment of the bag-assembling device 130 represented in the FIGS. 15, 16, the second securing means is also comprised of the two spaced apart rods 137, 138 that form the first securing means. Alternatively, the second securing means may be comprised of separate protruding elements.

The bag-assembling device 130 further comprises a third securing means connected to the support member 131 for releasably securing the collection bag thereto. The third securing means is comprised of two spaced apart protruding elements in the form of rods 141, 142 that perpendicularly extend from the side B of the elongated body 131 along the same axis as the rods 137, 138 of the first securing means, respectively. Like the rods 137, 138 of the first securing means, the tips of the rods 141, 142 are fitted with retaining elements 143, 144 for preventing a bag engaged on the rod from escaping therefrom during centrifugation of the bag assembly. Overall, the third securing means is identical to the first securing means save for the length of the rods, which is longer in the first securing means than in the third securing means.

The bag-assembling device 130 does not comprise a holder for a filter 27, and the filter 27 simply hangs within the central cavity of the rotor when the bag assembly is mounted therein.

It will be apparent to those skilled in the art that various modifications can be made to the bag-assembling device and method described herein. Thus, it should be understood that the invention is not limited to the subject matter discussed in the specification. Rather, the present invention is intended to cover modifications and variations.

1. A bag assembly for the separation of a composite liquid into at least two components, comprising:
a set of bags comprising:
a separation bag (1);
at least one product bag (2, 3, 4, 26), and
a product tube (15, 19, 23, 25) connecting the separation bag (1) to the at least one product bag (2, 3, 4, 26);
a bag-assembling device (40; 70; 90; 110; 130) for assembling the set of bags comprising:
a support member (41; 71; 91, 92; 111, 112; 131);
a mounting means (43, 44; 73; 93, 94; 115, 116; 135, 136), connected to the support member (41; 71; 91, 92; 111, 112; 131), for removably mounting the bag-assembling device (40; 70; 90; 110; 130) in a rotor of a centrifuge having a central cavity for containing the at least one product bag (2, 3, 4, 26); and
a first securing means (46, 47; 74; 95, 96, 97, 98; 119, 120; 137, 138) connected to the support member (41; 71; 91, 92; 111, 112; 131) for releasably securing the at least one product bag (2, 3, 4, 26) to the support member (41; 71; 91, 92; 111, 112; 131),
wherein the mounting means (43, 44; 73; 93, 94; 115, 116; 135, 136) and the first securing means (46, 47; 74; 95, 96, 97, 98; 119, 120; 137, 138) are so arranged with respect to each other that the at least one product bag (2, 3, 4, 26) occupies a determined position in the central cavity of a rotor when the bag-assembling device (40; 70; 90; 110; 130) in mounted therein.

2. A bag assembly according to claim 1, comprising a plurality of products bags, wherein the first securing means (46, 47; 74; 95, 96, 97, 98; 119, 120; 137, 138) is adapted to releasably secure the product bags (2, 3, 4, 26) to the support member (41; 71; 91, 92; 111, 112; 131) so that they form a compact stack.

3. A bag assembly according to claim 1, wherein the first securing means (46, 47; 74; 95, 96, 97, 98; 119, 120; 137, 138) is adapted to secure at least one product bag (2, 3, 4, 26) to the support member (41; 71; 91, 92; 111, 112; 131) by a peripheral edge thereof.

4. A bag assembly according to claim 1, wherein the at least one product bag (2, 3, 4, 26) is substantially rectangular and the first securing means (46, 47; 74; 95, 96, 97, 98; 119, 120; 137, 138) is adapted to secure the product bag (2, 3, 4, 26) to the support member (41; 71; 91, 92; 111, 112; 131) by an upper edge thereof.

5. A bag assembly according to claim 1, wherein the first securing means (46, 47; 74; 95, 96, 97, 98; 119, 120; 137, 138) is adapted to secure at least one product bag (2, 3, 4, 26) to the support member (41; 71; 91, 92; 111, 112; 131) by at least two areas thereof.

6. A bag assembly according to claim 5, wherein the first securing means comprises at least two spaced apart protruding elements (46, 47; 95, 96, 97, 98; 119, 120; 137, 138) for engaging two holes (14) in a peripheral area of at least one product bag (2, 3, 4, 26).

7. A bag assembly according to claim 6, wherein the first securing means further comprises at least two straps (99, 100, 101, 102), each strap having a first end connected to the support member (111, 112) and a second end connectable to one of the protruding elements (95, 96, 97, 98) so as to prevent a bag engaged on the protruding element from escaping therefrom.

8. A bag assembly according to claim 6, wherein the support member comprises an elongated body (41; 131) having two opposite lateral sides (A, B), the first and second protruding elements comprise two rods (46, 47; 137, 138) extending substantially perpendicularly from one side (A) of the body (41; 131) of the support member, and each rod has a tip fitted with a retaining extension (48, 49; 139, 140) for preventing a bag engaged on the rods (46, 47; 137, 138) from escaping therefrom.

9. A bag assembly according to claim 6, wherein the support member comprises a first and a second U-shaped elements (111, 112) having a straight flat base (113), the first and a second U-shaped elements (111, 112) are releasably connectable so that their respective straight flat base (113) are substantially parallel and define an oblong gap therebetween, and the two spaced apart protruding elements comprise two substantially parallel rods (119, 120) that are connected to the straight flat base (113) of the first U-shaped elements (111) and extend across the oblong gap to the straight flat base (113) of the second U-shaped elements (112).

10. A bag assembly according to claim 6, wherein the support member comprises a first and second flaps (91, 92) hinged together and the at least two spaced apart protruding elements (95, 96, 97, 98) extend from an outside surface of the flaps (91, 92).

11. A bag assembly according to claim 10 comprising a plurality of product bags (2, 3, 4, 26), wherein the first securing means comprises four spaced apart protruding elements (95, 96, 97, 98), two protruding elements (95, 96) extending from the first flap (91) and two protruding elements (97, 98) extending from the second flap (92).

12. A bag assembly according to claim 1, wherein the first securing means comprises at least one a jaw (74) for releasably grasping at least one product bag (2, 3, 4, 26) along a portion of a peripheral edge thereof.

13. A bag assembly according to claim 12 comprising a plurality of products bags (2, 3, 4, 26), wherein the support member (71) comprises an elongated body having two lateral sides and the first securing means comprises two jaws (74) respectively hinged to either side of the elongated body.

14. A bag assembly according to claim 1, wherein the mounting means (43, 44; 73; 93, 94; 115, 116; 135, 136) is connected to the support member (41; 71; 91, 92; 111, 112; 131) so that the support member (41; 71; 91, 92; 111, 112; 131) intersects a rotation axis of the rotor when the bag-assembling device (40; 70; 90; 110; 130) is mounted in the rotor.

15. A bag assembly according to claim 1, wherein:
the support member comprises an elongated portion (41; 71; 91, 92; 111, 112; 131) having two lateral ends, and
the mounting means comprises two extensions (43, 44; 73; 93, 94; 115, 116; 135, 136) extending at both ends of the elongated portion of the support member, and adapted to engage two corresponding recesses in a wall of a central cavity of a rotor so that the support member (41; 71; 91, 92; 111, 112; 131) extends across the cavity of the rotor when the lateral extensions are engaged in the recesses thereof.

16. A bag assembly according to claim 1, wherein:
the support member comprises an elongated body (131) having two opposite lateral sides (A, B),
the mounting means comprises a first and second protruding elements (137, 138) extending from one side (A) of the body of the support member (131), and the protruding elements (137, 138) have tips adapted to engage two recesses in a portion of a wall of a central cavity of a rotor so that the support member (131) extends substantially along the portion of wall when the protruding elements (137, 138) are engaged in the recesses thereof.

17. A bag assembly according to claim 1, wherein the mounting means (43, 44; 73; 93, 94; 115, 116; 135, 136) and the first securing means (46, 47; 74; 95, 96, 97, 98; 119, 120; 137, 138) are so arranged with respect to each other that the at least one product bag (2, 3, 4, 26) hangs substantially in an upright position when the bag-assembling device (40; 70; 90; 110; 130) is mounted in the rotor of a centrifuge.

18. A bag assembly according to claim 1, further comprising a second securing means (46, 47; 79, 80; 95, 96, 97, 98; 119, 120; 137, 138) connected to the support member (41; 71; 91, 92; 111, 112; 131) for releasably securing the separation bag (1) thereto.

19. A bag assembly according to claim 18, wherein the first securing means (46, 47; 74; 95, 96, 97, 98; 119, 120; 137, 138) and the second securing means (46, 47; 79, 80; 95, 96, 97, 98; 119, 120; 137, 138) are so arranged with respect to each other that the product tube (15, 19, 23, 25) forms a loop large enough for preventing the kinking thereof when the at least one product bag (2, 3, 4, 26) is secured to the support member (41; 71; 91, 92; 111, 112; 131) by the first securing means (46, 47; 74; 95, 96, 97, 98; 119, 120; 137, 138) and the separation bag (1) is secured to the support member (41; 71; 91, 92; 111, 112; 131) by the second securing means (46, 47; 79, 80; 95, 96, 97, 98; 119, 120; 137, 138).

20. A bag assembly according to claim 18, wherein the second securing means (46, 47; 79, 80; 95, 96, 97, 98; 119, 120; 137, 138) is adapted to secure the separation bag (1) to the support member (41; 71; 91, 92; 111, 112; 131) by a peripheral edge thereof.

21. A bag assembly according to claim 18, wherein the separation bag (1) is substantially annular or semi-annular and the second securing means (46, 47; 79, 80; 95, 96, 97, 98; 119, 120; 137, 138) is adapted to secure the separation bag (1) to the support member (41; 71; 91, 92; 111, 112; 131) by an inner peripheral edge thereof.

22. A bag assembly according to claim 18, wherein the second securing means (46, 47; 79, 80; 95, 96, 97, 98; 119, 120; 137, 138) is adapted to secure the separation bag (1) to the support member (41; 71; 91, 92; 111, 112; 131) by at least two areas thereof.

23. A bag assembly according to claim 22, wherein the second securing means comprises two spaced apart protruding elements (46, 47; 80; 95, 96, 97, 98; 119, 120; 137, 138) for engaging two apertures (11; 13) in a peripheral area of the separation bag (1).

24. A bag assembly according to claim 23, further comprising a handle (77) connected to the support member (71) and the two protruding elements (80) extend from the handle (77).

25. A bag assembly according to claim 18, wherein the first and the second securing means comprise the same two spaced apart protruding elements (46, 47; 95, 96, 97, 98; 119, 120; 137, 138) for engaging two apertures (13) in a peripheral area of the separation bag (1) and two holes (14) in a peripheral area of the at least one product bag (2, 3, 4, 26).

26. A bag assembly according to claim 1, further comprising a collection bag (29) connected to the separation bag (1) by a transfer tube (30).

27. A bag assembly according to claim 26, wherein the bag-assembling device (40; 70; 90; 110; 130) further comprises a third securing means (50, 51; 74; 95, 96, 97, 98; 119, 120; 141, 142) connected to the support member (41; 71; 91, 92; 111, 112; 131) for releasably securing the collection bag (29) to the support member (41; 71; 91, 92; 111, 112; 131).

28. A bag assembly according to claim 27, wherein the support member comprises an elongated body (41, 131) having a first and a second opposite lateral sides (A, B), the first securing means comprises two spaced apart protruding elements (46, 47; 137, 138) for engaging two holes (14) in a peripheral area of the at least one product bag (2, 3, 4, 26), and the third securing means comprises two spaced apart protruding elements (50, 51; 141, 142) for engaging two holes (14) in a peripheral area of the collection bag (29), whereby the protruding elements (46, 47; 137, 138) of the first securing means extend from the first side (A) of the elongated body (41, 131) and the protruding elements (50, 51; 141, 142) of the second securing means extend from the second side (B) of the elongated body (41, 131).

29. A bag assembly according to claim 1, wherein the bag-assembling device (40; 70; 90; 110; 130) further comprises a second securing means (46, 47; 79, 80; 95, 96, 97, 98; 119, 120; 137, 138) connected to the support member (41; 71; 91, 92; 111, 112; 131) for releasably securing the separation bag (1) to the support member (41; 71; 91, 92; 111, 112; 131), and a third securing means (50, 51; 74; 95, 96, 97, 98; 119, 120; 141, 142) connected to the support member (41; 71; 91, 92; 111, 112; 131) for releasably securing the collection bag (29) to the support member (41; 71; 91, 92; 111, 112; 131), whereby the second securing means (46, 47; 79, 80; 95, 96, 97, 98; 119, 120; 137, 138) and the third securing means (50, 51; 74; 95, 96, 97, 98; 119, 120; 141, 142) are so arranged with respect to each other that the transfer tube (30) forms a loop large enough for preventing the kinking thereof when the separation bag (1) is secured to the support member (41; 71; 91, 92; 111, 112; 131) by the second securing means (46, 47; 79, 80; 95, 96, 97, 98; 119, 120; 137, 138) and the collection bag (29) is secured to the support member (41; 71; 91, 92; 111, 112; 131) by the third securing means (50, 51; 74; 95, 96, 97, 98; 119, 120; 141, 142).

30. A bag assembly according to claim 1, further comprising a filter (27) connected to a tube (23; 25) connected to the at least one product bag (4; 26).

31. A bag assembly according to claim 30, wherein the bag-assembling device (40; 90) further comprises a holder (52; 103) connected to the support member (41; 91) for releasably holding the filter (27).

32. A bag assembly according to claim 31, wherein the mounting means (43, 44; 93, 94) and the filter holder (52; 103) are so arranged with respect to each other that the holder (52; 103) is located within the central cavity of a rotor when the bag-assembling device (40; 90) in mounted therein.

33. A bag assembly according to claim 32, wherein the filter (27) has a disk-like housing and the filter holder comprises a cylindrical portion (53, 105) for containing the filter (27) so that the filter (27) and the cylindrical portion (53, 105) of the holder are substantially concentric.

34. A bag assembly according to claim 33, wherein the filter holder is connected to the support member (41; 91) so that a central axis of the cylindrical portion (53, 103) of the holder is substantially perpendicular to a rotation axis of the rotor when the bag-assembling device (40; 90) is mounted in a rotor.

35. A bag assembly according to claim 34, wherein the filter holder (52, 103) and the first securing means (46, 47; 95, 96, 97, 98) are so arranged with respect to each other that the at least one product bag (2, 3, 4, 26) is substantially parallel to one of the circular side of the disk-like housing of the filter (27).

36. A bag assembly according to claim 30, wherein the bag-assembling device (40; 90) further comprises a first winding support (53, 54; 105) for coiling a portion of a tube (23; 25) connected to the filter.

37. A bag assembly according to claim 1, wherein the bag-assembling device (40) further comprises a second winding support (50, 51, 54, 60, 61, 62) for coiling a collection tube (32).

38. A bag assembly according to claim 1, further comprising a clamp (16) for selectively closing the product tube (15, 19, 23) connecting the at least one product bag (2, 3, 4) to the separation bag (1).

39. A bag-assembling device (40; 70; 90; 110; 130) for assembling a set of bags comprising a separation bag (1), at least one product bag (2, 3, 4, 26), and a product tube (15, 19, 23, 25) connecting the separation bag (1) to the at least one product bag (2, 3, 4, 26), the bag-assembling device (40; 70; 90; 110; 130) comprising
a support member (41; 71; 91, 92; 111, 112; 131);
a mounting means (43, 44; 73; 93, 94; 115, 116; 135, 136), connected to the support member (41; 71; 91, 92; 111, 112; 131), for removably mounting the bag-assembling device (40; 70; 90; 110; 130) in a rotor of a centrifuge having a central cavity for containing the at least one product bag (2, 3, 4, 26); and
a first securing means (46, 47; 74; 95, 96, 97, 98; 119, 120; 137, 138) connected to the support member (41; 71; 91, 92; 111, 112; 131) for releasably securing the at least one product bag (2, 3, 4, 26) to the support member (41; 71; 91, 92; 111, 112; 131),
wherein the mounting means (43, 44; 73; 93, 94; 115, 116; 135, 136) and the first securing means (46, 47; 74; 95, 96, 97, 98; 119, 120; 137, 138) are so arranged with respect to each other that the at least one product bag (2, 3, 4, 26) occupies a determined position in the central cavity of a rotor when the bag-assembling device (40; 70; 90; 110; 130) in mounted therein.

40. A bag-assembling device according to claim 39 for a plurality of products bags, wherein the first securing means (46, 47; 74; 95, 96, 97, 98; 119, 120; 137, 138) is adapted to releasably secure the product bags (2, 3, 4, 26) to the support member (41; 71; 91, 92; 111, 112; 131) so that they form a compact stack.

41. A bag-assembling device according to claim 39, wherein the first securing means (46, 47; 74; 95, 96, 97, 98; 119, 120; 137, 138) is adapted to secure at least one product bag (2, 3, 4, 26) to the support member (41; 71; 91, 92; 111, 112; 131) by a peripheral edge thereof.

42. A bag-assembling device according to claim 39, wherein the at least one product bag (2, 3, 4, 26) is substantially rectangular and the first securing means (46, 47; 74; 95, 96, 97, 98; 119, 120; 137, 138) is adapted to secure the product bag (2, 3, 4, 26) to the support member (41; 71; 91, 92; 111, 112; 131) by an upper edge thereof.

43. A bag-assembling device according to claim 39, wherein the first securing means (46, 47; 74; 95, 96, 97, 98; 119, 120; 137, 138) is adapted to secure at least one product bag (2, 3, 4, 26) to the support member (41; 71; 91, 92; 111, 112; 131) by at least two areas thereof.

44. A bag-assembling device according to claim 43, wherein the first securing means comprises at least two spaced apart protruding elements (46, 47; 95, 96, 97, 98; 119, 120; 137, 138) for engaging two holes (14) in a peripheral area of at least one product bag (2, 3, 4, 26).

45. A bag-assembling device according to claim 44, wherein the first securing means further comprises at least two straps (99, 100, 101, 102), each strap having a first end connected to the support member (111, 112) and a second end connectable to one of the protruding elements (95, 96, 97, 98) so as to prevent a bag engaged on the protruding element from escaping therefrom.

46. A bag-assembling device according to claim 44, wherein the support member comprises an elongated body (41; 131) having two opposite lateral sides (A, B), the first and second protruding elements comprise two rods (46, 47; 137, 138) extending substantially perpendicularly from one side (A) of the body (41; 131) of the support member, and each rod has a tip fitted with a retaining extension (48, 49; 139, 140) for preventing a bag engaged on the rods (46, 47; 137, 138) from escaping therefrom.

47. A bag-assembling device according to claim 44, wherein the support member comprises a first and a second U-shaped elements (111, 112) having a straight flat base (113), the first and a second U-shaped elements (111, 112) are releasably connectable so that their respective straight flat base (113) are substantially parallel and define an oblong gap therebetween, and the two spaced apart protruding elements comprise two substantially parallel rods (119, 120) that are connected to the straight flat base (113) of the first U-shaped elements (111) and extend across the oblong gap to the straight flat base (113) of the second U-shaped elements (112).

48. A bag-assembling device according to claim 44, wherein the support member comprises a first and second flaps (91, 92) hinged together and the at least two spaced apart protruding elements (95, 96, 97, 98) extend from an outside surface of the flaps (91, 92).

49. A bag-assembling device according to claim 48 for a plurality of product bags (2, 3, 4, 26), wherein the first securing means comprises four spaced apart protruding elements (95, 96, 97, 98), two protruding elements (95, 96) extending from the first flap (91) and two protruding elements (97, 98) extending from the second flap (92).

50. A bag-assembling device according to claim 39, wherein the first securing means comprises at least one a jaw (74) for releasably grasping at least one product bag (2, 3, 4, 26) along a portion of a peripheral edge thereof.

51. A bag-assembling device according to claim 50 for a plurality of products bags (2, 3, 4, 26), wherein the support member (71) comprises an elongated body having two lateral sides and the first securing means comprises two jaws (74) respectively hinged to either side of the elongated body.

52. A bag-assembling device according to claim 39, wherein the mounting means (43, 44; 73; 93, 94; 115, 116; 135, 136) is connected to the support member (41; 71; 91, 92; 111, 112; 131) so that the support member (41; 71; 91, 92; 111, 112; 131) intersects a rotation axis of the rotor when the bag-assembling device (40; 70; 90; 110; 130) is mounted in the rotor.

53. A bag-assembling device according to claim 39, wherein:
the support member comprises an elongated portion (41; 71; 91, 92; 111, 112; 131) having two lateral ends, and
the mounting means comprises two extensions (43, 44; 73; 93, 94; 115, 116; 135, 136) extending at both ends of the elongated portion of the support member, and adapted to engage two corresponding recesses in a wall of a central cavity of a rotor so that the support member (41; 71; 91, 92; 111, 112; 131) extends across the cavity of the rotor when the lateral extensions are engaged in the recesses thereof.

54. A bag-assembling device according to claim 39, wherein:
the support member comprises an elongated body (131) having two opposite lateral sides (A, B),
the mounting means comprises a first and second protruding elements (137, 138) extending from one side (A) of the body of the support member (131), and the protruding elements (137, 138) have tips adapted to engage two recesses in a portion of a wall of a central cavity of a rotor so that the support member (131) extends substantially along the portion of wall when the protruding elements (137, 138) are engaged in the recesses thereof.

55. A bag-assembling device according to claim 39, wherein the mounting means (43, 44; 73; 93, 94; 115, 116; 135, 136) and the first securing means (46, 47; 74; 95, 96, 97, 98; 119, 120; 137, 138) are so arranged with respect to each other that the at least one product bag (2, 3, 4, 26) hangs substantially in an upright position when the bag-assembling device (40, 70, 90, 110) is mounted in the rotor of a centrifuge.

56. A bag-assembling device according to claim 39, further comprising a second securing means (46, 47; 79, 80; 95, 96, 97, 98; 119, 120; 137, 138) connected to the support member (41; 71; 91, 92; 111, 112; 131) for releasably securing the separation bag (1) thereto.

57. A bag-assembling device according to claim 56, wherein the first securing means (46, 47; 74; 95, 96, 97, 98; 119, 120; 137, 138) and the second securing means (46, 47; 79, 80; 95, 96, 97, 98; 119, 120; 137, 138) are so arranged with respect to each other that the product tube (15, 19, 23, 25) forms a loop large enough for preventing the kinking thereof when the at least one product bag (2, 3, 4, 26) is secured to the support member (41; 71; 91, 92; 111, 112; 131) by the first securing means (46, 47; 74; 95, 96, 97, 98; 119, 120; 137, 138) and the separation bag (1) is secured to the support member (41; 71; 91, 92; 111, 112; 131) by the second securing means (46, 47; 79, 80; 95, 96, 97, 98; 119, 120; 137, 138).

58. A bag-assembling device according to claim 56, wherein the second securing means (46, 47; 79, 80; 95, 96, 97, 98; 119, 120) is adapted to secure the separation bag (1) to the support member (41; 71; 91, 92; 111, 112; 131) by a peripheral edge thereof.

59. A bag-assembling device according to claim 56, for an annular or semi-annular separation bag (1), wherein the second securing means (46, 47; 79, 80; 95, 96, 97, 98; 119, 120; 137, 138) is adapted to secure the separation bag (1) to the support member (41; 71; 91, 92; 111, 112; 131) by an inner peripheral edge thereof.

60. A bag-assembling device according to claim 56, wherein the second securing means (46, 47; 79, 80; 95, 96, 97, 98; 119, 120; 137, 138) is adapted to secure the separation bag (1) to the support member (41; 71; 91, 92; 111, 112; 131) by at least two areas thereof.

61. A bag-assembling device according to claim 60, wherein the second securing means comprises two spaced apart protruding elements (46, 47; 80; 95, 96, 97, 98; 119, 120) for engaging two apertures (11, 13) in a peripheral area of the separation bag (1).

62. A bag-assembling device according to claim 61, further comprising a handle (77) connected to an upper part of the support member (71) and the two protruding elements (80) extend from the handle (77).

63. A bag-assembling device according to claim 56, wherein the first and the second securing means comprise the same two spaced apart protruding elements (46, 47; 95, 96, 97, 98; 119, 120; 137, 138) for engaging two apertures (13) in a peripheral area of the separation bag (1) and two holes (14) in a peripheral area of the at least one product bag (2, 3, 4, 26).

64. A bag-assembling device according to claim 39, further comprising a third securing means (50, 51; 74; 95, 96, 97, 98; 119, 120; 141, 142) connected to the support member (41; 71; 91, 92; 111, 112; 131) for releasably securing to the support member (41; 71; 91, 92; 111, 112; 131) a collection bag (29) connected to the separation bag (1) by a transfer tube (30).

65. A bag-assembling device according to claim 64, wherein the support member comprises an elongated body (41; 131) having a first and a second opposite lateral sides (A, B), the first securing means comprises two spaced apart protruding elements (46, 47; 137, 138) for engaging two holes (14) in a peripheral area of the at least one product bag (2, 3, 4, 26), and the third securing means comprises two spaced apart protruding elements (50, 51; 141, 142) for engaging two holes (14) in a peripheral area of the collection bag (29), whereby the protruding elements (46, 47; 137, 138) of the first securing means extend from the first side (A) of the elongated body (41; 131) and the protruding elements (50, 51; 141, 142) of the second securing means extend from the second side (B) of the elongated body (41; 131).

66. A bag-assembling device according to claim 39, further comprising a second securing means (46, 47; 79, 80; 95, 96, 97, 98; 119, 120; 137, 138) connected to the support member (41; 71; 91, 92; 111, 112; 131) for releasably securing the separation bag (1) to the support member (41; 71; 91, 92; 111, 112; 131) and a third securing means (50, 51; 74; 95, 96, 97, 98; 119, 120; 141, 142) connected to the support member (41; 71; 91, 92; 111, 112; 131) for releasably securing to the support member (41; 71; 91, 92; 111, 112; 131) a collection bag (29) connected to the separation bag (1) by a transfer tube (30), whereby the second securing means (46, 47; 79, 80; 95, 96, 97, 98; 119, 120; 137, 138) and the third securing means (50, 51; 74; 95, 96, 97, 98; 119, 120; 141, 142) are so arranged with respect to each other that the transfer tube (30) forms a loop large enough for preventing the kinking thereof when the separation bag (1) is secured to the support member (41; 71; 91, 92; 111, 112; 131) by the second securing means (46, 47; 80; 95, 96, 97, 98; 119, 120; 137, 138) and the collection bag (29) is secured to the support member (41; 71; 91, 92; 111, 112; 131) by the third securing means (50, 51; 74; 95, 96, 97, 98; 119, 120; 141, 142).

67. A bag-assembling device according to claim 39, further comprising a filter holder (52; 103) connected to the support member (41; 91) for releasably holding a filter (27) connected to a tube (23; 25) connected to the at least one product bag (4; 26).

68. A bag-assembling device according to claim 67, wherein the mounting means (43, 44; 93, 94) and the filter holder (52; 103) are so arranged with respect to each other that the holder (52; 103) is located within the central cavity of a rotor when the bag-assembling device (40, 90) in mounted therein.

69. A bag-assembling device according to claim 67, for a filter (27) having a disk-like housing, wherein the filter holder (52, 103) comprises a cylindrical portion (53, 105) for containing the filter (27) so that the filter (27) and the cylindrical portion (53, 105) of the holder are substantially concentric.

70. A bag-assembling device according to claim 69, wherein the filter holder is connected to the support member (41; 91) so that a central axis of the cylindrical portion (53, 105) of the holder is substantially perpendicular to a rotation axis of the rotor when the bag-assembling device (40; 90) is mounted in a rotor.

71. A bag-assembling device according to claim 70, wherein the filter holder (52, 103) and the first securing means (46, 47; 95, 96, 97, 98) are so arranged with respect to each other that the at least one product bag (2, 3, 4, 26) is substantially parallel to one of the circular side of the disk-like housing of the filter (27), when at least one product bag (2, 3, 4, 26) is secured to the support member (41; 91) by the first securing means and (46, 47; 95, 96, 97, 98) and a filter (27) is held in the filter holder (52, 103).

72. A bag-assembling device according to claim 67, further comprising a first winding support (53, 54; 105) for coiling a portion of a tube (23; 25) connected to the filter.

73. A bag-assembling device according to claim 39, further comprising a second winding support (50, 51, 54, 60, 61, 62) for coiling a collection tube (32).

74. A method for manufacturing a bag assembly for the separation of a composite liquid into at least two products comprising the steps of:
Providing bag-assembling device having
a support member;
a securing means connected to the support member for releasably securing a plurality of product bags and a separation bag to the support member;
a filter holder connected to the support member for holding a filter;
a winding support connected to the support member for coiling a section of tube connected to a filter around the winding support;
Inserting a filter connected to two sections of a tube into the filter holder;
Coiling a section of tube connected to the filter around the winding support;
Securing a plurality of product bags to the support member by means of the securing means so as to form a stack of the product bags;
Securing a separation bag to the support member by means of the securing means
Connecting one product bag to one section of the tube connected to the filter; and
Connecting each other product bag to the separation bag by a tube so as to form at least one loop of tube large enough to prevent the tube from kinking.
